(19) United States
(12) Patent Application Publication
(10) Pub. No.: US 2022/0348516 A1
(43) Pub. Date: Nov. 3, 2022

(54) CEREAL BASED ADJUVANT FOR AGROCHEMICAL PERFORMANCE

(71) Applicant: One Vision Enterprises, Inc., Pacoima, CA (US)

(72) Inventors: Broc Sondgroth, Hollister, CA (US); Eric Berg, Tarzana, CA (US)

(73) Assignee: One Vision Enterprises, Inc., Pacoima, CA (US)

(21) Appl. No.: 17/725,440

(22) Filed: Apr. 20, 2022

Related U.S. Application Data
(60) Provisional application No. 63/180,858, filed on Apr. 28, 2021.

(51) Int. Cl. C05F 11/02; C05G 3/70; C05G 3/50; C05G 5/12; C05G 3/80

(52) U.S. Cl. CPC C05F 11/02; C05G 3/70; C05G 3/50; C05G 5/12; C05G 3/80

(57) ABSTRACT

The present invention is an adjuvant for use as an isolate suspension that is used to enhance various agrochemicals such as fertilizers, plant growth formulae, fungicides, insecticides, and herbicides. The adjuvant is derived from a cereal or legume and enhances active ingredients in the agrochemical by creating more absorption surface area per droplet, and increases optimum chemical penetration into the leaf stoma due to the complex protein relationship upon deposition.

### CROSS-REFERENCES TO RELATED APPLICATIONS

This application claims priority to U.S. Provisional Patent Application No. 63/180,858, filed Apr. 28, 2021, the contents of which is incorporated herein by reference in its entirety.

### BACKGROUND

Scientists are constantly trying to improve the performance of agricultural products using chemical additives. In this field, an adjuvant is a material added to such a product to aid or modify the action of an agrochemical or the physical characteristics of the mixture. Adjuvants are commonly used in agriculture to improve the performance of herbicides, fertilizers, and pesticides, and can lead to better mixing and handling, increased effectiveness and safety, better distribution, and drift reduction.

In order to be effective, herbicides must overcome a variety of barriers (morphological, biological, and environmental) before gaining entry into a plant. For example, trichomes on the leaf surface can reduce herbicide efficacy by inhibiting absorption of spray droplets before they contact the epidermal surface. Environmental stress (e.g., hot, dry weather) may cause the plant to develop a thicker than normal wax layer, or increase other defensive structures such as reducing the plant's metabolic and transport processes, which in turn reduce the effectiveness of the herbicide. Because of these and other conditions, adjuvants have been developed to assist herbicides. When properly uses, adjuvants can serve to:

allow better mixing and handling with herbicide active ingredients;

reduce or even eliminate spray application problems (e.g., drift reduction);

allow contact to a weed target, increase droplet coverage, spray retention, and droplet drying;

increase herbicide cuticle penetration and cellular accumulation;

significantly enhance and improve an herbicide's efficacy so that the concentration or total amount of herbicide required to achieve a given effect is reduced;

decrease the amount of herbicide applied and lower total costs for weed control;

enhance the formulation's ability to kill the targeted vegetation without harming the other plants; and

from an environmental aspect, can reduce leaching of herbicide through the soil profile.

The main types of adjuvants currently in use can be grouped into three general types: Activators, Spray modifiers and Utility modifiers.

1. Activators

Activators modify certain herbicide droplet characteristics, including droplet size and viscosity of the herbicide spray, evaporation rate, etc. Usually, they increase herbicide activity and/or herbicide spread, leading to greater absorption into plant tissue, and can also promote rainfastness, and decrease photodegradation of the herbicide. There are three categories of activators: surfactants, wetting agents, and oils.

1.1. Surfactants

Surfactants are a type of activators designed to improve the dispersing/emulsifying, absorbing, spreading, wetting, sticking, and/or penetrating properties of the spray mixture. Surfactants primarily influence the ability of herbicides to penetrate the leafs waxy cuticle. Most herbicides are prepared in a solution of water. Water is a chemically polar material and thus can be repelled by the waxy surface of leaves. Water containing a surfactant reduces the surface tension of water on plants, spread in a wet thin layer over a waxy leaf surface, and allow the herbicide formulation to enter into the plant. Surfactants can be classified in four groups on the basis of the ability to ionize the aqueous solution. Those groups are:

Nonionic—are the most commonly used in agriculture and can be mixed readily with any herbicide. They produce little or no ionization in water (no electrical charge). Organosilicone and silicone surfactants are two types of nonionic surfactants.

Cationic—are not often used with herbicides. They have a positive charge.

Anionic—rarely used with herbicides, but mainly used in cosmetics, household cleaners, many domestic detergents, etc. They have a negative charge.

Ampholytic (amphoteric)—have a both positive and negative charge, that is, in aqueous solution are capable forming cations or anions.

1.2. Wetting Agents

Wetting agents increase the ability of water to displace air or liquids from the leaf surface, allowing it to be wet by the herbicide. Wetting agents help spread the solution more evenly over the leaf.

1.3. Oils

Oils increase the retention time of a solution on leaves, allowing for an increase in herbicide uptake. Oils mostly contain emulsifiers to allow them to mix with water. Some benefits associated with oils include reduced rainfast periods, more uniform droplet size (drift reduction), less spray evaporation, and better penetration of herbicide into waxy leaves.

Oils can be mineral or plant-based with different contents of surfactant in formulation (3%--20%). They can be classified as:

Crop oils

Dormant oils

Crop oil concentrates

Vegetable oils

Vegetable oil concentrate

Modified vegetable oil, and

Modified vegetable oil concentrate

1.3.1. Crop Oils

Crop oils are emulsifiable petroleum oil-based products containing up to 5% w/w surfactant and the remainder of phytobland oil.

1.3.2. Dormant Oils

Dormant oils are horticultural spray oils applied during the dormant phase of the targeted plant. There are “quick-break” or dormant oils that use a very low amount (2%--5%) of emulsifier for dispersion into the spray tank.

1.3.3. Crop Oil Concentrates (COC)

COC are the most commonly used oils in agriculture. They were introduced to the market in the 1960s. COC are emulsifiable petroleum oil-based products containing 5%-20% w/w surfactant and a minimum of 80% w/w phytobland oil. COC enhanced activity of aryloxyphenoxy propionates, cyclohexadinones, triazines, phenoxy acid urea herbicides, imidazolinones, etc.

1.3.4. Vegetable Oils

Vegetable oils are also used as herbicide adjuvants. The base in formulation is oil from sunflower, soybean, oilseed rape, peanut, or corn, which is combined with surfactants in different content.

1.3.5. Vegetable Oil Concentrates

Vegetable oil concentrates are emulsifiable vegetable oil products containing 5%-20% w/w surfactant and a minimum of 80% w/w vegetable oil. There are some vegetable oil concentrates used in the same manner as the crop oil concentrates, typically based upon canola or soybean oil, using 5%-10% emulsifier for dispersion.

1.3.6. Modified Vegetable Oil

Modified vegetable oil is oil extracted from seeds that have been chemically modified. Methylated seed oils (MSO) are vegetable oils mainly from oilseed rape or sunflower esterified with alcohol ethanol to get methyl esters.

1.3.7. Modified Vegetable Oil Concentrate

Modified vegetable oil concentrate is an emulsifiable, chemically modified vegetable oil product containing 5%-20% w/w surfactant and remain chemically modified vegetable oil. Some of the best vegetable-based products are those modified (derivatized) to methyl and other lower alkyl esters such as methylated soybean oil, methyl sunflowerate, or ethyl canolate.

2. Spray Modifiers

Spray modifiers affect the delivery and placement of the spray solution. They confine or alter the physicochemical characteristics of the spray solution, and make the herbicide spray easier to aim, reduce herbicide drift in the air, and cause the spray to more readily adhere to the plant. Spray modifiers include:

Thickening agents (i.e., invert emulsions and polymers)

Stickers

Spreaders

Spreader-stickers

Foaming agents

Humectants, and

UV absorbents

2.1. Thickening Agents

Thickening agents modify the viscosity (thickness) of spray mixtures. They control drift or slow evaporation after the spray has been deposited on the target area. Slowing evaporation is important when using systemic herbicides, because they can penetrate the plant cuticle only as long as they remain in solution. Invert emulsions, polymers, and drift control agents are three types of thickening agents commonly used in herbicide applications.

2.1.1. Invert Emulsions

Invert emulsions are mixtures of inverting oil and water, having a mayonnaise-like appearance on the water surface and a snowflake-like appearance under the water surface. Depending on their solubility, herbicides dissolve in either the oil or water component. The oil in the case of invert emulsions reduces the evaporation, produces bigger particles, reduces drift problems and can be sprayed on wet foliage.

2.1.2. Polymers

Polymers are a very large, chain-like carbon molecules made up of monomers, up to 40,000 carbons in length, forming a thick mucus-like material which helps to break the surface tension of water and enhance sinking of herbicides.

2.1.3. Drift Control Agents

Drift control agents modify spray characteristics to reduce spray drift, usually by minimizing small droplet formation. They are generally polyacrylamide or polyvinyl polymers.

2.2. Stickers

Stickers assists the spray deposit to adhere or stick to the leaf surface and may be measured in terms of resistance to time, wind, water, mechanical action, or chemical action. Stickers may be heavy petroleum fractions, water-soluble polymers, acrylic latex, epoxidized seed oils (similar to boiled linseed oil, which dries on exposure to air), or alkylphenol condensates called resins. Stickers are commonly used in field crops (like corn and soybeans) where residue on leaves is not a problem. They are usually used for application of fungicides and insecticides rather than herbicides.

2.3. Spreaders

Spreaders are compounds that cause the surface tension of the herbicide to be reduced in such a way that it easily spreads into a very thin film over a leaf surface. Spreaders increase the efficiency of the herbicide dramatically. Typically, the alcohol ethoxylates such as tridecanol ethylene oxide allow a spread diameter increase of two to three times. They may contain fatty acids, latex, aliphatic alcohols, crop oils such as cottonseed, or inorganic oils.

2.4. Spreader-Stickers

Spreader-stickers are essentially combinations of stickers and spreaders. They provide additional retention of herbicide in wet conditions. They are usually used with contact insecticides and fungicides for which complete coverage is critical.

2.5. Foaming Agents

Foaming Agents are compounds that facilitate formation of foam for reducing drift and evaporation. These agents are used infrequently for drift control of herbicide applications.

2.6. Humectants

Humectants, like stickers, increase the amount of time that the herbicide is on the leaf, in a form available for uptake. When water evaporates from the spray droplet and the herbicide becomes a crystalline residue, it is no longer available for uptake into the leaf. Humectants keep the spray deposit moist and in true solution, and therefore extend the time that it is available for absorption.

2.7. UV Absorbents

UV absorbents protect herbicides from the deleterious effect(s) of sunlight. They may do this by either physical or chemical processes, such as by increasing the rate of herbicide uptake into the cuticle, or by absorbing the UV-light themselves.

3. Utility Modifiers

Utility modifiers help minimize handling and application problems. They do not directly improve efficacy, but widen the conditions when an herbicide can be used or maintain the integrity of the spray solution. For example, utility modifiers reduce foaming, increase solubility, modify pH, or reduce spray drift.

Types of modifiers include emulsifiers, dispersants, stabilizing agents, coupling agents, co-solvents, compatibility agents, buffering agents, antifoam agents, and ammonium fertilizers.

3.1. Emulsifiers

Emulsifiers are molecules with one hydrophilic and one hydrophobic end. They make it possible for water and oil to become finely dispersed in each other, creating a stable, homogeneous, smooth emulsion. Most crop oils contain emulsifiers to allow them to mix with water and some contain various levels of surfactants.

3.2. Dispersants

Dispersants are chemicals that are sprayed on a surface oil slick to break down the oil into smaller droplets that more readily mix with the water. These water soluble dispersants have been found to be unique and highly effective dispersants for water insoluble agricultural suspension concentrate formulations.

3.3. Stabilizing Agents

Stabilizing agents act as thickening or gelling agents that increase the viscosity of the final product. These agents stabilize emulsions, either by adsorbing to the outer surface of oil droplets. Stabilization can be achieved in agricultural suspension and emulsion through the use of fine-particle-size solids and fine liquid droplets in the disperse phase along with appropriate dispersants and wetting agents.

3.4. Coupling Agents

Coupling agents are compounds which provide a chemical bond between two dissimilar materials, usually an inorganic and an organic. Organosilanes are well-suited in this application because of the ability to incorporate an organic-compatible functionality and an inorganic-compatible functionality within the same molecule.

3.5. Cosolvents

Cosolvents are defined as water-miscible organic solvents that are used in liquid herbicide formulations to increase the solubility of poorly water-soluble substances or to enhance the chemical stability of an herbicide.

3.6. Compatibility Agents

Compatibility agents allow simultaneous application of two or more ingredients. They are most often used when herbicides are applied in liquid fertilizer solutions.

3.7. Buffering Agents

Buffering agents are used to change the pH and hardness of the water and to increase the dispersion or solubility of herbicides in alkaline or acid waters used in making up an herbicide solution. Ammonium sulfate (AMS) is sometimes added to reduce hard water problems.

3.8. Antifoam Agents

Antifoam agents reduce foaming in spray mixtures that require vigorous agitation. They are particularly useful in soft water. Antifoam agents are usually silicone-based and used at 0.1% or less of the total spray volume.

3.9. Ammonium Fertilizers

Ammonium fertilizers are often added to spray solutions with foliar applied herbicides. The two most common ammonium fertilizers used are ammonium sulfate (AMS) and urea ammonium nitrate (UAN) solution (28-0-0). The exact mechanism of action for ammonium fertilizers is not known although increased herbicide uptake into plant has been reported.

Surfactants are the most widely used and probably the most important of all adjuvants. They can be especially effective in improving the biological activity of many herbicides. Nonionic surfactants (NIS) improved the effect of nicosulfuron and enhanced glyphosate absorption, which was 20 times greater and the spread of spray drop was 200 greater than with no adjuvants added.

Considering environmental factors, rain shortly after an herbicide application is one of the most detrimental issues for herbicide performance. Adjuvants have been shown to improve the rainfastness of herbicides and the effect on rainfastness should be considered when selecting an adjuvant. A number of studies have been published that outline the beneficial effects of utility modifiers in reducing the critical rain-free period after the foliar herbicidal application. The reduction of the critical rain-free period was attributed to decreased liquid surface tension of glyphosate caused by the utility modifier and subsequent promotion of stomatal infiltration of glyphosate into the plant.

Despite widespread use of adjuvants to improve the performance of certain agrochemical products, there are drawbacks to using many of the chemicals developed for this purpose, including cost, suitability to the environment, effectiveness, and availability. The present invention addresses many of the drawbacks of earlier adjuvants by using a plentiful, cost effective bio-friendly plant-based isolate that is effective in increasing the performance of certain agrochemicals.

### SUMMARY OF THE INVENTION

The present invention is an adjuvant for use with agrochemicals that is derived or use a cereal (e.g., corn, wheat, canola, soy) or legume (e.g. soybean) as an isolate suspension to enhance the performance and characteristics of the agrochemicals. The adjuvant of the present invention enhances the active ingredients in products such as herbicides, fungicides, insecticides, biologicals, PGRs, fertilizers, and utility products by, among other things, increasing the absorption surface area per droplet. The present invention also increases the chemical penetration of the agrochemical into the leaf stoma due to the adjuvant's complex protein and carbohydrate relationship upon deposition. This rapid induction then translates to maximum absorption potential while remaining less obstructive/invasive to the leaf/plant, and yielding healthier produce than current technologies. The concentration of the adjuvant to the agrochemical can vary from 0.05% to 100% depending on use rate and effect desired.

The adjuvant of the present invention has also been shown to reduce driftable fines by altering common use ingredients into larger droplets that have less shear and splatter properties. This composition has further proven to adhere and protect the application for two or more rainfall events or irrigation cycles, leading to a fuller spectrum of available treatments in harsh weather conditions. The present invention when incorporated into certain agrochemicals demonstrates natural defoaming properties, which is important since foaming can be a major concern to formulation aids in pesticides. For example, the glufosinate molecule, a widely used herbicide, typically contains an SLS-based surfactant that naturally produces a high foam product. Conversely, the present invention helps eliminate the need for extra foam retardants to correct this issue when used in formulation in conjunction with or as a substitute for other adjuvants. Additionally most defoamers are silicone based and have to be used minimally as their metal properties can cause compatibility problems when added to the formula and likely have to be added only as a tank mixture.

### DETAILED DESCRIPTION OF THE PREFERRED EMBODIMENTS

The plant-based isolate used in the present invention is derived from certain common cereals or legumes, such as corn, wheat, soy, and barley. The plant material is ground or crushed and the oil is extracted. The residual cell mass, which in the case of canola or wheat is primarily the carbohydrate portion of the cotyledon, consists of cell walls, membranes and microfilaments and is separated from the solution and dried.

The term “agrochemical” includes biopesticides or mixtures thereof. Included within the term “agrochemicals” are herbicides, fungicides, bactericides, acaricides, insecticides, gametocides, nematocides, algicides, rodenticides, molluscides, insect baits, repellents, pheromones, insect growth regulators, fertilizers, micronutrients, soil conditioners, growth regulators and the like, or mixtures thereof. It should also be understood that the term “agrochemical” also includes agricultural, horticultural, fruticultural and floricultural use.

The isolate can be added to the agrochemical as described above. The resultant formulas may be formulated as dry flowables, water dispersible granules, broadcast granules, suspensions, emulsions, tablets, briquettes and so forth. When the product is formulated as a granule, tablet or briquette, it has good hardness and does not tend to crumble or dust, thereby reducing operator exposure to the biological control agent, a matter of considerable health concern. The product however can be readily dispersed in water for spray application or the like.

The following examples illustrate the invention.

### Example 1

Glyphosate comes in several formulations but the most common is a standard 41% glyphosate acid. Traditionally 5%-25% of the inert ingredients include a surfactant or inert ingredients to activate the herbicide and assist in delivery. A product using the present invention would comprise a formulation that consists of 41% glyphosate and 5%-25% of a cereal based adjuvant in place of the standard surfactant.

### Example 2

Dicamba comes in multiple formulations but the most common is a standard 49% Dicamaba salt acid. Traditionally 5%-20% of the inert ingredients include a surfactant or drift agent in inert ingredients to activate the herbicide and assist in delivery. A product using the present invention would comprise a formulation that consists of 49% Dicamba and 5%-25% of a cereal based adjuvant in place of the standard surfactant and Drift reduction agent.

We claim:

1. A method for improving a performance of an agrochemical comprising combining the agrochemical with an adjuvant having a cereal or legume base selected from a group comprising corn, wheat, oat, canola, and soybean, the adjuvant comprising solids obtained from a process of grinding the cereal base and extracting oils therefrom, drying and milling said solids into an isolate having a particle size between about 20 and 200 microns, introducing the isolate into the adjuvant in a solution of up to twenty-five percent (25%) by weight of isolate, five to twenty-five percent (5%-25%) nonionic or anionic surfactant, and water.

2. The method of claim 1, wherein a ratio of the adjuvant solution to isolate is controlled by a particle size of the solids.

3. The method of claim 1, wherein the adjuvant solution includes soil micronutrients.

4. The method of claim 1, wherein the adjuvant solution includes a wetting agent.

5. The method of claim 1, wherein the adjuvant solution excludes a wetting agent.

6. The method of claim 1, wherein the adjuvant solution includes a humectant.

7. The method of claim 1, wherein the adjuvant solution includes silica.

8. The method of claim 1, wherein the adjuvant solution includes clay.

9. The method of claim 1, wherein the adjuvant solution includes oat protein.

10. The method of claim 1, wherein the adjuvant solution includes a dispersant.

11. The method of claim 1, wherein the adjuvant solution includes a surfactant.

13. The method of claim 1, wherein the adjuvant solution includes an emulsifier.

14. The method of claim 1, wherein the adjuvant solution is processed into water dispersible granules.

15. An agricultural treatment for improving a performance of an agrochemical, comprising:
an agrochemical;
an adjuvant having a cereal or legume base selected from a group comprising corn, wheat, oat, canola, and soybean, the adjuvant comprising an isolate having a size between 20 and 200 microns, said isolate suspended in a solution; and
wherein the adjuvant when combined with the agrochemical reduces a foaming characteristic of the agrochemical.

16. The agricultural treatment of claim 15, wherein a ratio of the adjuvant to isolate is controlled by the isolate size.

17. The agricultural treatment of claim 15, wherein the adjuvant solution includes a soil micronutrient.

18. The agricultural treatment of claim 15, wherein the adjuvant solution includes a wetting agent.

19. The agricultural treatment of claim 15, wherein the adjuvant solution excludes a wetting agent.

20. The agricultural treatment of claim 15, wherein the adjuvant solution includes a humectant.

21. The agricultural treatment of claim 15, wherein the adjuvant solution includes silica.

22. The agricultural treatment of claim 15, wherein the adjuvant solution includes clay.

23. The agricultural treatment of claim 15, wherein the adjuvant solution includes oat protein.

24. The agricultural treatment of claim 15, wherein the adjuvant solution includes a dispersant.

25. The agricultural treatment of claim 15, wherein the adjuvant solution includes a surfactant.

26. The agricultural treatment of claim 15, wherein the adjuvant solution includes an emulsifier.

27. The agricultural treatment of claim 18, wherein the adjuvant solution is processed into water dispersible granules.
